(19) United States
(12) Patent Application Publication
(10) Pub. No.: US 2003/0087648 A1
(43) Pub. Date: May 8, 2003

(54) End user to mobile service provider message exchange system based on proximity

(76) Inventors: Alex Naum Mezhvinsky, Westbourne Park (AU); Boris Mezhvinsky, Cumberland Park (AU)

Correspondence Address: David A. Jackson, KLAUBER & JACKSON, 4th Floor, 411 Hackensack Street, Hackensack, NJ, 07601, US

(21) Appl. No.: 10/288,560

(22) Filed: Nov. 5, 2002

Related U.S. Application Data
(63) Continuation of application No. PCT/AU01/00498, filed on May 2, 2001.

(30) Foreign Application Priority Data
May 5, 2000 (AU) PQ7312
May 30, 2000 (AU) 37767/00

(51) Int. Cl. H04Q 7/20; H04M 1/00; H04B 1/38

(52) U.S. Cl. 455/456; 455/422; 455/445; 455/563

(57) ABSTRACT

Disclosed is a method and means for facilitating direct access by an end user of a service to a mobile service provider that is typically mobile, wherein the end user is able to select a desired mobile service based primarily on the proximity of that mobile service provider to that end user at the time the end user requires that service.

This invention relates to a method and means for facilitating direct access from an end user of a service to the mobile service provider who is typically mobile and wherein the end user is able to select the desired mobile service provider based primarily on their proximity to that end user.

### BACKGROUND

In this specification a sole operator chauffer service will be used as an example of a mobile service provider. Also in this specification, a person requiring a chauffer service will be used as an example of an end user.

However, there is potential for use of the described method and means by a great variety of end users and desirably an equally great variety of mobile service providers. Some examples of services which are likely to be mobile and for which proximity of those mobile service providers to an end user is an important factor include couriers, taxis chauffers, plumbers, electricians, home handy persons, transportation drivers, sales persons, health care and fitness program providers are but a few. Furthermore, impulse purchasers or persons wishing to be contacted by sales persons representing the services to be provided may also be encouraged to make contact with these types of mobile service providers if they know that their presence is nearby at the time.

Until the present, an end user would need to know the preferable means of contact for the mobile service provider, typically by making a call to the mobile service providers mobile telephone. The end user needs to know the particular mobile telephone number and even if the mobile service provider is available, they may be too far away to provide prompt delivery of the required service.

Central Taxi dispatch services exist because there is a need to efficiently control the provision of a taxi to an end user. However, dispatch services do not put the end user in direct contact with the mobile service provider namely the taxi driver, neither does the end user choose the particular taxi as that is left to the dispatcher or computerised dispatch system. The dispatch system is typically arranged to allocate the nearest available suitable taxi.

If the end user has a particular need, such as a five passenger taxi, that may also be accommodated by such a system, but only after additional information is obtained from the end user and the dispatcher or computer system is arranged to accommodate that requirement if indeed that information is available.

What the end user does not know is that there could exist a closer available and suitable taxi from another taxi company. The end user only chooses the dispatch service of a particular taxi company and they do not choose the nearest suitable taxi of any particular taxi company.

End users are typically faced with limited choices and it is impossible for them to know where typically mobile service providers are located at any one time or their current availability to provide the service required of the end user. It is an aim of this invention to increase the choices available to an end user as well as to eliminate or reduce the problems which currently exist, in the action of an end user obtaining the services of a mobile service provider. Furthermore, it is an aim to provide a means to the end user to directly access a mobile service provider without the need for third party involvement.

There already exist a variety of ways to determine the geographical location of a mobile service provider, for example they may have a Global Positioning Systems (GPS) receiver integrated with a terrestrial radio, or their mobile is geographically locatable using Mobile Positioning Services provided by the mobile network infrastructure. Furthermore, end users of services have both personal computer (PC) and wireless (Cellular Mobile Telephone, etc) technologies capable of providing a means to receive information from the mobile service provider as well as information relating to services and their geographical location. Thus this invention involves a novel combination of these devices, systems and various steps that will allow an end user to select a mobile service provider based on the geographical location of the mobile service provided relative to that end user.

The invention also provides a means and method to exchange messages so as to transact the provision of a service to an end user by a mobile service provider according to a message sent by the end user.

### BRIEF DESCRIPTION OF THE INVENTION

According to a first aspect of the present invention, there is provided a method of providing access to an end user to one or more mobile service providers, the method including;

receiving from the end user a request to access one or more mobile service providers within a predetermined region;

supplying the end user with data relating to the geographical location of the one or more mobile service providers within said predetermined region;

receiving from the end user data relating to a selected one of the one or more mobile service providers within the predetermined region; and

providing details of the end user to the selected mobile service provider.

According to a second aspect of the present invention, there is provided a system for providing access to an end user to one or more service providers, the system including:

an end user interface to allow the end user to request and receive data relating at least to the geographical location of one or more mobile service providers within a predetermined region;

an application server for receiving and providing data to and from the end user interface;

one or more databases storing data relating to the one or more mobile service providers that are registered;

a map server for processing and providing data relating to the geographical location of the one or more service providers to the application server, and for retrieving and updating the one or more databases;

a mobile location engine for determining the location of the one or more mobile service providers and providing this data to the map server.

According to a third aspect of the invention, there is provided a method of providing access to an end user to one or more mobile service providers providing a service, the method including:

receiving from the end user a request to access one or more mobile service providers within a predetermined region;

automatically selecting one or more mobile service providers in accordance with one or more criteria provided by the end user; and

providing details of the end user to the selected one or more mobile service providers.

### BRIEF DESCRIPTION OF THE FIGURES

FIG. 1 depicts an example of systems used to determine geographical location of a mobile service provider by locating the geographical location of their mobile telephone and other systems that associate that geographical location information with the type of service available from the mobile service provider as well as a means to display that information to an end user via the Internet;

FIG. 2 depicts a practical implementation of the system of the present invention;

FIG. 3 illustrates the flow of information involved in a new user requesting a display of taxis within a given region;

FIG. 4 illustrates the flow of information involved in a new Web user requesting the nearest taxi;

FIG. 5 illustrates the flow of information involved in a WAP user requesting the nearest taxi;

FIG. 6 illustrates the flow of information involved in a SMS user requesting the nearest taxi;

FIG. 7 illustrates the flow of information involved in a phone user requesting the nearest taxi via an IVR system;

FIG. 8 illustrates the flow of information involved in a phone user requesting the nearest taxi via a call centre;

FIG. 9 depicts a display of information compiled by a WEB server based on a specified request of the end user; and

FIG. 10 depicts a further display of information compiled by a WEB server based on a modified request of the end user.

### DESCRIPTION OF THE EMBODIMENT OF THE INVENTION

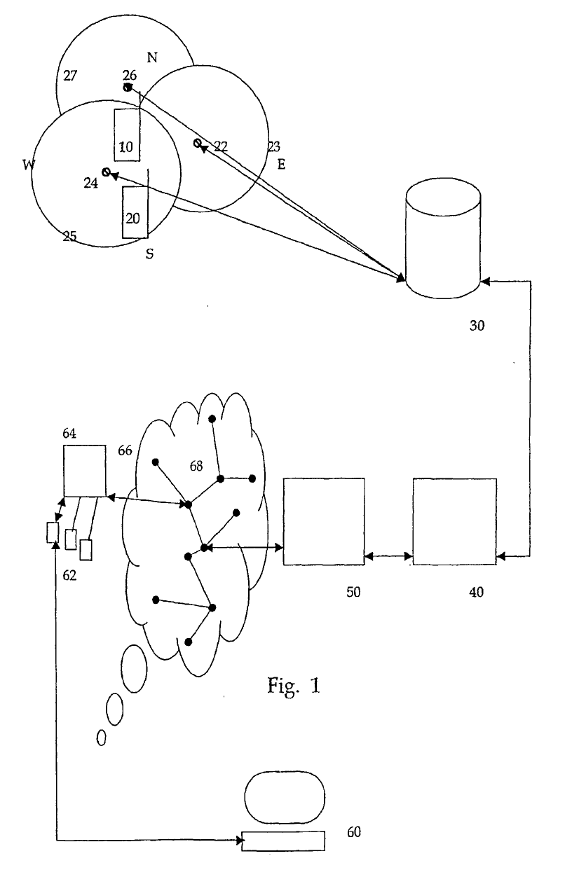

FIG. 1 depicts one embodiment of the invention wherein mobile telephones (10, 20) mobile base stations 22, 24 and 26 and respective mobile coverage areas 23, 25 and 27, the mobile network controller 30, computer interface 40 to the mobile telephone network, an Internet WEB server 50 and an end user access means, in this environment, an end user equipment 60, all combine to display to the end user the geographical location of at least one mobile telephone (10, 20) and hence the geographical location of a mobile service provider, in this example, two chauffer service providers, and for the end user to be able to select either of those services providers based on their geographical location relative to that end user.

The term WEB is used to identify that a device has connected to or can connect to the Internet which is a worldwide network of interconnected computers that primarily use TCP/IP to exchange digital data. However, these terms are relatively new and their meaning could evolve as technology which delivers the features described herein changes.

In this embodiment a mobile service provider (chauffer driver) has a mobile telephone 10 which during normal usage communicates with a mobile telephone network to provide voice and data exchange with other telephone users and databases.

The mobile telephone network is also capable of determining the geographical location of a mobile telephone 10 that is referred to as a Network Centric Technique. In a preferred system, it is possible to use a measure of the signal quality of a mobile mobile telephone transmission received by at least three base stations (22,24 and 26). Those signal quality values are used to calculate the geographical location of the mobile telephone.

Signal quality measures may include the signal strength of a control channel received by at lease three base stations or the bit error rate of the control/voice channel received by those at least three base stations and by using standardised path loss assumptions, it is possible to triangulate a likely geographical location of the mobile. Since the exact geographical location of each of the base stations is known it is possible to graphically represent this geographical location technique by drawing a circle about each base station representative of the calculated distance the mobile is from the base station and where the three circles intersect the mobile is likely to be in close proximity. The accuracy of the determination of the geographical location of the mobile using this technique is dependant to a large degree on the accuracy of the standardised path loss assumptions which will be most affected by the judgement of the type and density of attenuation elements there are between the mobile telephone and the base stations. At least the worst case would isolate the mobile telephone to the area of a single network telephony cell but by processing information from adjacent cells it is possible to locate a mobile within 200 metres and sometimes more accurately.

The above technique for mobile phone geographical location determination is but one of many currently available, being developed or that will become available in the future. Existing techniques include Angle of Arrival (AOA); Time of Arrival (TOA); Time Difference of Arrival (TDOA) and combinations of them (eg AOA+TOA); as well as Assisted techniques which use a Global Positioning System (GPS) receiver in the mobile phone to improve the accuracy of the geographical location determination within reasonable time constraints.

As the additional data exchange and processing required of the mobile network is not inconsequential this geographical location-determining feature of the network is not commonly used. However, if a mobile user is also a mobile service provider they may indicate their willingness to have the geographical location of their mobile determined.

Thus, the geographical location of that mobile telephone 10 is known to the mobile networks at all times. An option on the mobile service providers telephone can be chosen to control when this feature is available. Information as to the mobile service providers current geographical location can then be made available to others and in particular to end users desirous of knowing the geographical location of certain mobile service providers.

The mobile service provider may also use options operable via their mobile telephone to indicate their non-availability or other status types. For example, the mobile service provider may be currently unavailable for hire and does not want to be disturbed, alternatively the mobile service provider may be providing a service to a customer but is still available for future booking: or furthermore the service provided may be free for hire, and yet further the mobile service provider may be able to offer a cheaper rate for their services for a predetermined time so even though they may be further away from an end user, than another mobile service provider, that end user will be presented extra incentive to choose the mobile service provider offering a cheaper fare structure. Other options may also be available.

Currently available mobile phones can be customised using a “Subscriber Identification Module (SIM) Card Tool Kit Feature” that allows various options to be pre-programed into the mobile. Programs can be provided to facilitate one or more of the desirable features described herein in relation to the needs of the mobile service provider.

For example, special function can be assigned to the mobile keypad buttons, such as cursor control buttons, #2 for UP, #4 for LEFT, #6 for RIGHT and #8 for DOWN. Another button could be assigned the ACCEPT function, another for the REJECT function and other for an ENGAGED function. Yet others can be used for indicating the operator's status such as FREE, etc.

Thus Wireless Application Protocol (WAP) enabled mobile telephones are not necessary for the provision of a simplified version of the invention.

More sophisticated SIM cards may be adapted to display mapping features so as to allow the mobile to be used by an end user as well as a mobile service provider to make proximity determined selections.

The mobile network may provide mobile telephone and data services using GSM or CDMA communication technologies, both of which, provide mobile phone locating capabilities which until now have only been used by the company controlling the network.

In this embodiment however, geographical location information about appropriately authorised mobile telephones plus any other data such as availability, can be made available to a computer interface 40. The computer interface 40 may not be part of the Internet WEB server 50 to be described later in the specification.

The computer interface 40 receives data from the mobile telephone network, that may be in the form of data packets, each packet having the mandatory “TO” and “FROM” address information plus a data payload. The data payload may comprise in this embodiment, the unique mobile telephone International Mobile Equipment Identification (IMEI) number and/or International Mobile Subscriber Identity (IMSI); the geographical location of that mobile telephone in an agreed format (e.g. latitude and longitude, etc) and availability data possibly in the form of codes so as to keep the size of the packet as small as possible.

Typical error detection and correction codes may also be communicated.

The communication protocol used between the mobile network controller 30 and the computer interface 40 may preferably be Transmission Control Protocol/Internet Protocol (TCP/IP). The computer interface 40 will preferably have extensive memory capability and processing power so that it may convert the incoming payload into more useable data. For example, the IMEI number needs to be translated into the preferred display image for that mobile service provider and other data needs to be manipulated in the manner to be described herein.

The exact form of the displayed information may be standardised so that all chauffer services are displayed by name and a standard logo. However, arrangements could be made to highlight in a selected manner, particular ones of those chauffer services as a paid service for particular chauffer services that are willing to pay for such an added feature.

The format of information into which the incoming data is arranged may be in the form of tables that are being updated, at a predetermined rate, as new data packets arrive.

Geographical location data for each mobile phone needs to be translated into a form suitable for determining its relative geographical location on a display device. The display device will preferably show a predetermined area at any one time in which the end user is located. Preferably, the end user's geographical location is known to the device controlling the display. The end user will preferably provide it's geographical location to their own end user equipment 60, which will be used, by that equipment to control the displayed area or is communicated to the computer interface 40 which uses that information.

The actual area displayed on the display, may be arranged to increase or decrease a predetermined amount at the will of the user, but so as to make the display process more accurate and quicker to respond, the computer interface 40 will have previously prepared the relevant values for predetermined display areas, as a way of reducing the processing load caused by these requested variations in the display area.

Alternatively and certainly more preferably, the end user located in the centre of the displayed area and the exact diameter of the area displayed to the user can be varied at the will of the end user. Thus either the computer interface 40 or the WEB server 50 may be required to recalculate the geographical location of one or more mobile service providers in the desired area displayed to the end user. Alternatively, an application running under the user's WEB browser may be capable of performing some or all of the recalculating required.

If a user's personal computer is used to do the recalculating, the WEB server 50 is merely an agent of the end user who has in this embodiment connected their end user equipment 60, such as a personal computer, to the Internet so as to access the WEB server 50.

The mechanism for access by the end user to the WEB server is typically via a dial up modem connection to an Internet Service Provider (ISP) and in FIG. 1 this is depicted by a Public Switch Telephone Network (PSTN) link to one of the plurality of modems 62 at the ISP location 64. The Internet 66 includes a link from the ISP to an Internet backbone 68, which is in communication with the WEB server 50.

In this embodiment, the end user utilises a PC 60 having a WEB browser thereon into which the Universal Resource Locater (URL) of the WEB server 50 is entered. Preferably, access to the WEB server 50 is free for end users and payment by mobile service providers is the price of displaying their service icon and their geographical location to end users. The mobile service provider is therefore charged for this service and/or related bookings consequent to their selection by an end user and this supports the cost of providing the system.

As described in more detail below, the end user can use other access means instead of the PC 60, such as a WAP enabled mobile phone, SMS phone, or standard PSTN phone.

Various forms of advertising can also be displayed to the end user and the cost of that advertising may also support the running costs of the system.

There are however many modes of use of the invention, one of which includes offering a specialised service to large fleet owners or controllers. For example, a select group of end users, such as the personnel at the head office of a courier company, has the need to know the geographical location of each member of its courier fleet. In this situation, as long as each courier driver in the fleet has a mobile telephone or at least a mobile transmit/receive device dedicated to geographical location determination tasks and/or emergency response alert task, the end user in this example, the courier company head office, can log onto a restricted access portion of the WEB server 50 and determine the geographical location of each of their fleet at any time. Clearly, this arrangement can be made to operate in the dispatch mode wherein messages directed to any of the fleet members can be communicated with via the transport company's access to the WEB server 50 and thence to the mobile telephone network. Furthermore, it is possible for the courier driver to communicate messages direct to the dispatcher using SMS, possibly from pre-programmed keys, eg. a particular button on the mobile will transmit an SMS acknowledging receipt of a message and confirmation that it is understood, a further button could indicate successful delivery of a package, etc.

The WEB based arrangement described above offers a form of diversity for the dispatching tasks of the courier company, if the courier company offices are unavailable for any reason, access to the relevant WEB server could be achieved using any suitable browser located on any PC which itself could be located anywhere, thus the task of dispatching the courier fleet can be continued at an alternative site even in times of disaster.

WEB server 50 is preferably arranged to provide a WEB page suitable for the monitor being used by the end user. In the example described in detail herein, the display is a PC monitor which supports a large range of colour and resolution and thus is able to display quite detailed small areas and even sufficiently detailed large areas compared to that which is available for example on a mobile telephone display.

The invention is however, not limited to use on a PC monitor. It is possible for an end user to require a particular service while they themselves are mobile. An end user may require a chauffer service from a restaurant in which case, with the embodiment described herein, it will be possible for that mobile end user to access the geographical location of the nearest chauffer services via the end user's mobile telephone. If using a mobile phone, the end user's actual location can be determined automatically by the mobile network itself, for example using a standard networkcentric technique.

Mobile telephones already have the capability of accessing data provided from databases and in a limited fashion access WEB servers containing information. To compensate for the relatively small information displays available in mobile telephones and the variable data exchange rate between the remote server and the mobile telephone, WEB browsers of reduced complexity have been developed to reside on the mobile telephone (microBrowsers) that are designed to accept modified Hyper Text Markup Language (HTML) code from WEB browsers which use a Wireless Markup Language (WML) to describe the content to be displayed on the mobile screen.

The WML is designed to carefully and legibly use the smaller area and resolution of mobile telephone displays for the display of information. For example the options available from the microBrowser menu has been reduced, the fonts displayed are adapted to the resolution available, the size and shape of icons and other displayed data is sized to suit the display and moving elements of the display eliminated or provided at a much reduced resolution or rate compared to that available via other WEB access mediums.

As mobile data rates increase and displays increase in resolution and size, more detail and movement can be made available.

Mobile telephones having a Wireless Application Protocol (WAP) capability will be better able to deliver WEB browsing capabilities to the user of those mobile telephones since they adequately address the small display area and data rate exchange issues at the moment and will only improve in the future.

The end user may also use other types of WEB access devices such as Personal Digital Assistants (PDAs) which have a larger display than current mobile telephones and are purpose designed to allow for data input and display and in particular for limited WEB browsing. These devices will also be enhanced by the use of WAP devices and WML if they use wireless technologies to access the Internet. The advent of Bluetooth™ technology will also provide another alternative.

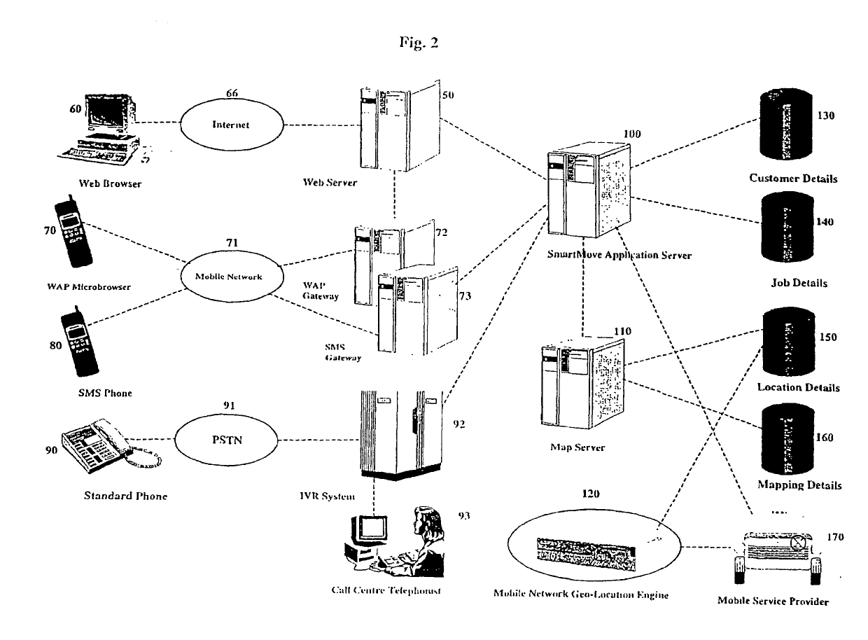

A preferred practical embodiment of the above will now be described in more detail with reference to FIGS. 2-8.

An end user is able to access the system of the present invention by various means including via a web browser (for example a PC) 60, a WAP microbrowser (for example WAP enabled mobile phone) 70, an SMS mobile phone 80 and/or a standard telephone 90. Web browser or PC 60 accesses the system of the present invention via the Internet 66 through web server 50 which is connected to the application server 100. WAP microbrowser 70 is connected to the application server 100 via mobile network 71 and WAP gateway 72. The SMS phone 80 access is achieved via the mobile network 71 through an SMS gateway 73. If using a standard telephone, this telephone is connected via a standard PSTN 91 which is connected directly to an (IVR) system 92 which is in turn connected to the application server 100. Alternatively, the standard phone access may be made via a call centre telephonist 93 which connects the end user directly to the application server 100.

The core components of the system of the present invention include application server 100, map server 110, mobile network geo location engine 120 and database components which may contain customer details 130, job details 140, location details 150 and mapping details 160. Mobile network geo location engine 120 is generally an existing part of a mobile network.

Service provider 170 is in this practical implementation depicted as a taxi. However, as described above, the service provider can be the provider of any service including chauffeur service, plumber or even an emergency service provider.

It will also be understood by the person skilled in the art that while each of the components of the apparatus of the present invention is depicted as a separate element, these are in fact separate logical elements and may all be contained within a single physical unit.

The web access logical component is required to provide the end user with the ability to access the apparatus of the present invention via the Internet using a web browser, such as on a standard PC 60. This component consists of a web browser client and a web server with the following functionality requirements: a dynamic navigation management, which provides the end user with the ability to input user related information (for example name and address), create and modify customer profiles, view geographic maps, view end user position on the map, view positions of mobile service providers on the map (relative to the end user location), view service provider specific information (for example service type and discounts), choose and initiate a service request (for example ordering the nearest taxi), view service request results (for example order confirmation number), initiate a request for the operator assistance and initiate a request to follow (view) the updated position of the service provider on the map.

The web access logical component is also required to direct the interface to the application server 100.

The WAP access logical component is required to provide the end user who is equipped with a WAP enabled mobile phone for example, with the ability to access the system while being mobile. This consists of WAP microbrowser 70, WAP gateway 72 (which is generally an existing component of the mobile network 71) and web server 50.

The WAP access logical components is required to forward the CLI (calling line identification) information to the application server 100, to enable the mobile network geo location engine 120 to position the end user. Alternatively, the mobile service provider could automatically provide a geo-location tag in each data packet.

The required end user functionality is essentially the same as for the web access logical component, with the exception of the mapping functionality due to the display resolution limnitations of current mobile phones. In the future, this may not be the case and a mapping feature could be also implemented.

The SMS access logical component is required to provide the end user, who is equipped with an SMS capable mobile phone 80 with the ability to access the apparatus of the present invention while being mobile. This component consists of the SMS mobile phone 80 and SMS gateway 73, which is generally an existing component of mobile network 71.

The SMS access logical component is also required to forward the CLI information to the application server 100, to enable the mobile network geo location engine 120 to position the end user. If accessing the system using the SMS option, the end user functionality is limited to the ability to send an SMS message with a service request, and the ability to receive an SMS message with the service request results (for example order confirmation number). This can be conducted in a standard manner as well known to the person skilled in the art.

If using a standard PSTN telephone, the logical access component for this is required to provide the end users with the ability to access the apparatus of the present invention via a standard phone connection. This consists of a standard phone interface 90, interactive voice response system (IVR) 92, and/or a call centre interface 93 for manual assistance. This component is required to provide a menu driven navigation control, allow the end user to provide CLI information to the application server 100 for end user geo location purposes, and the ability to provide end users with a choice of services based on the service type, location and price.

It is conceivable that an automatic dispatch system as currently exists for taxis, can be provided by the system of the present invention. A caller can access IVR system 92 via their PSTN phone 90, and place a request via IVR 92, specifying service type, cost range etc. This information is then forwarded to and processed by application server 100, which then provides the end user with a choice of service providers via IVR 92. The end user then selects a desired service provider, and application server 100 initiates an automatic dispatch instruction to the selected taxi or other service provider.

The application server 100 is the centre of the system of the present invention and runs main application programs and provides the following:

Front End Interface Functionaity

This includes the processing of end user supplied information via the web browser, processing of SMS messages (with the ability to send SMS messages via the SMS gateway 73), processing of IVR responses, processing of the CLI information, and provision of the mapping and service information to the end user (for example locations of nearest services and/or confirmation number).

Database Interface Functionality

This involves the processing and forwarding of end user location information to the customer details database 130, processing and forwarding order related information to the job details database 140 and retrieving and processing of database information (customer and job details).

Map Server Interface Functionality

This involves the processing and forwarding of end user location information to the map server 110 and processing of map server responses.

Mobile Network Geo Location Engine Interface Functionality

This involves the processing and forwarding of end user CLI information to the mobile network geo location engine 120 and the processing of mobile network geo location responses.

The map server 110 processes end user location information (provided by application server 100), delivers location and mapping information to the sever 100, requests and retrieves service provider location information from the location details database 150 and requests and retrieves mapping information from the mapping details database 160.

The mobile network geo location engine 120 provides the following functionalities:

End User Positioning

This provides the ability to receive end user CLI information from application server 100, process end user CLI information, poll the end user, based on the CLI, to establish his/her current geographic location, forward the end user's current geographic location to the application server 100, and forward the end user's current geographic location to the location details database 150. The location information can be in the form of x,y coordinates, corresponding to generally used latitude and longitude coordinates, which can then be referenced to a standardised map reference, as would be understood by the person skilled in the art.

Mobile Service Provider Positioning

This involves receiving a polling request, including CLI, from a mobile phone of the mobile service provider 170, processing the polling request and mobile service provider CLI information, polling the mobile service provider 170, based on the CLI, to establish his or her current geographic location and forwarding of the mobile service provider's 170 current geographic location to the location details database 150.

The database logical component is responsible for the storage of all data information for the system of the present invention. This component consists of customer details database 130, job details database 140, location details database 150 and mapping details database 160. This logical component provides the complete functionality of a standard relational database management system and provides features including SQL support, concurrent access, corruption detection, back-up facilities, auto sizing and security administration.

The geographic positioning requirement of both the end user and the mobile service provider can be achieved by utilising either a network centric solution (where the location is determined by the mobile network using a mobile geo location feature as discussed in detail above) or a GPS assisted solution (where the location is determined by a GPS equipped mobile phone or other units).

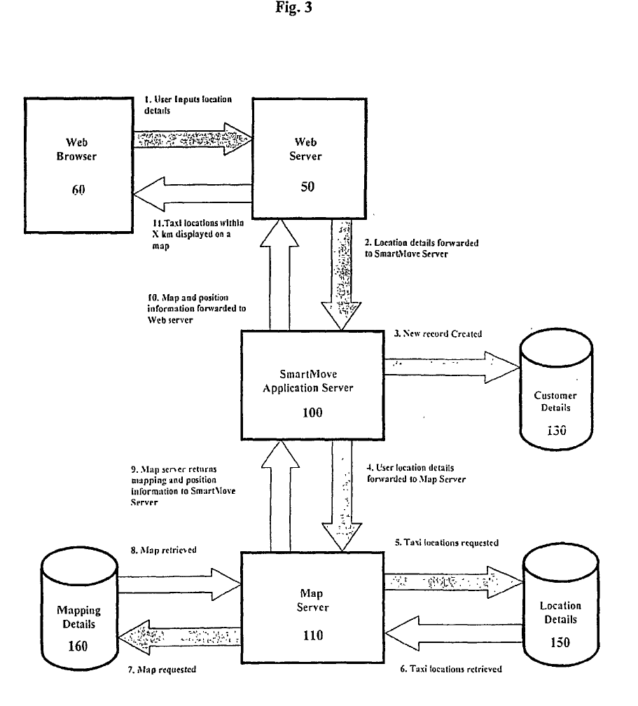

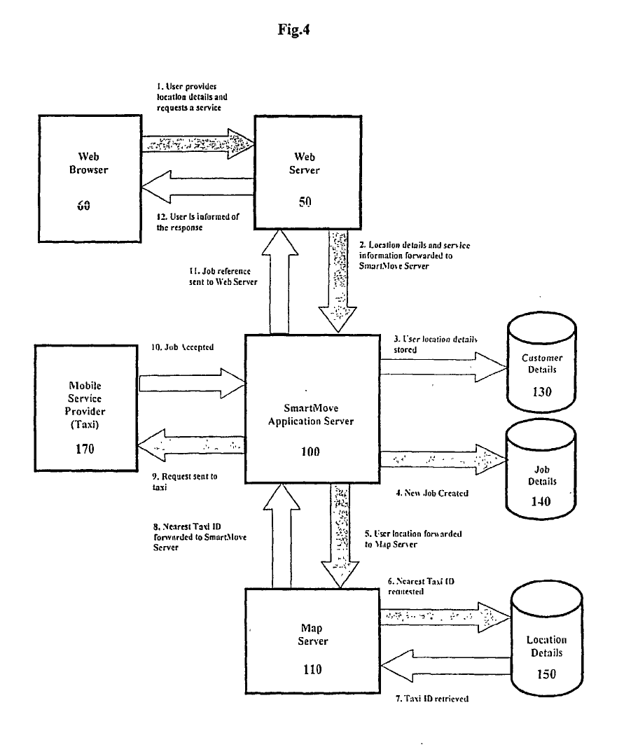

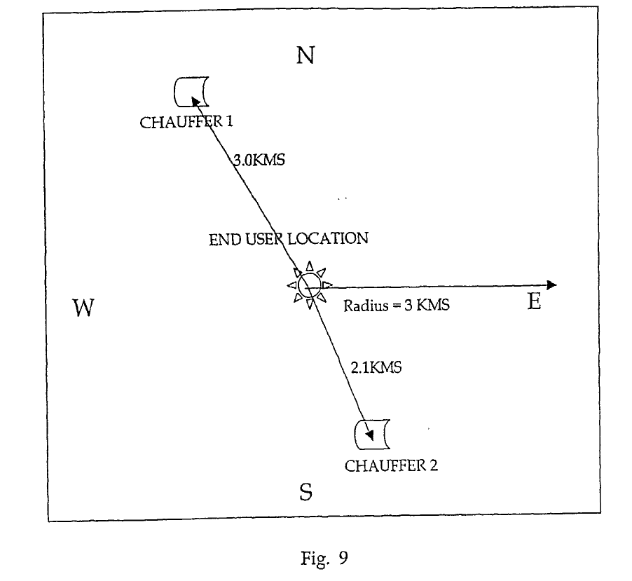

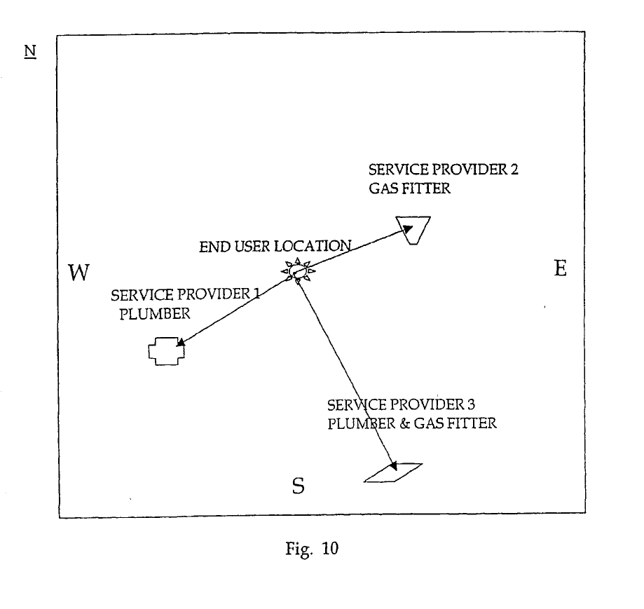

The general flow of information involved in a new user requesting a display of taxis within a given region is illustrated in FIG. 3. If for example an end user wishes to order a taxi, the system of the present invention allows the user to access and view the location of any specified taxi within a predetermined geographical region about the end user (see FIGS. 9 and 10 for further details relating to this aspect). To initiate this operation, the end user accesses web browser 60, which may be a common PC, and inputs their location details. This could be in the form of either an x,y coordinate data which is referenced to a standard map, or may in fact simply be the user's current location as a street address. The web server 50 receives these details and forwards these to application server 100. Application server 100 then causes a new record to be created, including the new customer location details and stores these in customer details database 130. The user location details are also forwarded to map server 110 which accesses location details database 150 containing location details of all service providers 170 registered with the system. Location details relating to each eligible service provider are then returned to map server 110 which forwards this information to application server 100. If a graphical output has been requested by the end user, map server 110 also provides a map request instruction to mapping details database 160 which provides map server 110 with details relating to the required map. This data is also forwarded to application server 100 which forwards both map and position information to web server 50 which displays the location of various taxis within a given region about the end user as specified by that end user. Alternatively, the system may preselect a given region area automatically. The end user is then in a position to view which taxis are closest to it and give it the option of ordering that taxi. To accomplish this, the end user provides its location details via web browser 60 and requests the service of a particular taxi as identified by a particular identification data. Alternatively, the system may automatically select the closest taxi or the taxi with the cheapest fare, depending upon any pre-programmed instructions. These details are provided to web server 50 which are in turn forwarded to application server 100. The user location details are then stored in customer details database 130 and a data record is generated which effectively creates a new job order. These details are stored on job details database 140. The user location information is also forwarded to map server 110 which requests from location details database 150 the ID of the nearest taxi. This information is then returned to map server 110 which is in turn forwarded to application server 100. Application server 100 then causes a request to be sent to the previously identified taxi who can then accept or reject the service request. If the mobile service provider accepts the job, a job reference is sent from application server 100 to web server 50 which then informs the end user that the job has been accepted and that the service provider is on its way. This flow of information is illustrated in FIG. 4.

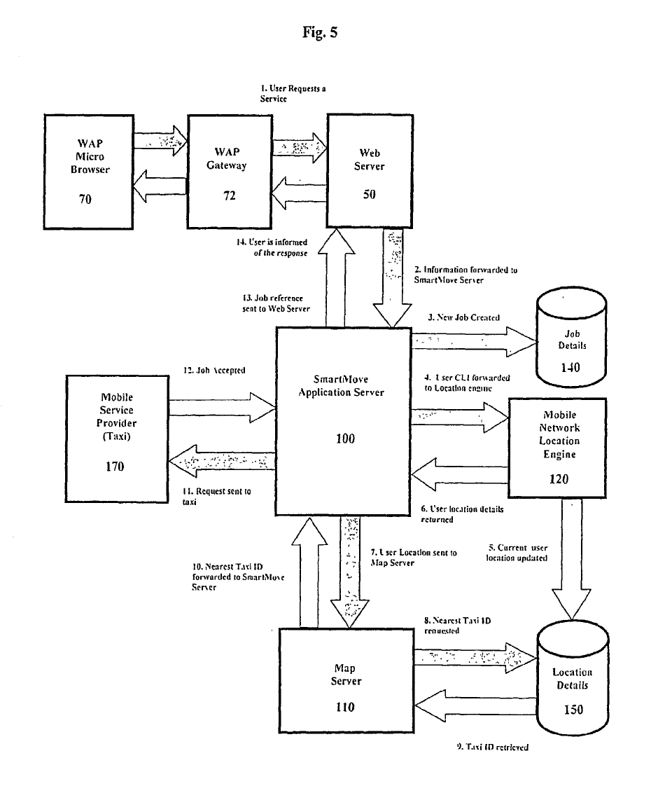

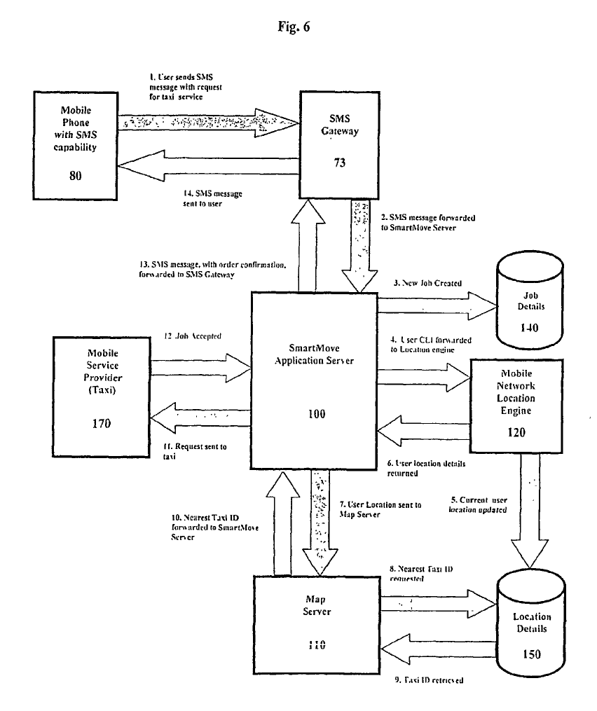

In the case where the end user is in possession of a WAP enabled mobile phone for example and wishes to call a taxi, the flow of information is illustrated in FIG. 5. In order to do this, the user accesses their WAP rnicrobrowser 70 and requests a service via WAP gateway 72 which is connected to web server 50 as described above. This request information is then forwarded to application server 100 which forwards and stores information in job details database 140, to create a new job order as described above and also forwards the user CLI information to the mobile network geo location engine 120. Location engine 120 updates the current user location information and stores this updated information in location details database 150. These updated user location details are then returned to application server 100. Application server 100 then sends the updated user location information to map server 110 which requests the identification of the nearest taxi from the location details database 150 and receives the requested information as described above. The ID of the nearest taxi is then forwarded to application server 100 which then forwards the request to this identified service provider. Once again, the service provider can accept or reject the job request and if accepted, this information is returned to application server 100 which causes a job reference to be sent to web server 50 and ultimately to the end user via WAP gateway 72 and WAP micro browser 70. In FIG. 6, there is shown the flow of information involved in an end user accessing the system via an SMS phone. The flow of information between the application server 100 and job details database 140, mobile network location engine 120, location details database 150, map server 110 and mobile service provider 170 are identical to that described above. The interface between application server 100 and the end user is specific to an SMS system and involves the user sending an SMS message with their request for a taxi service via a mobile phone with SMS capability 80 to SMS gateway 73 which then interfaces directly with application server 100. Upon completion of the information processing, application server 100 delivers an SMS message with an order confirmation to SMS gateway 73 which in turn forwards this message to the end user via their SMS enabled mobile phone 80.

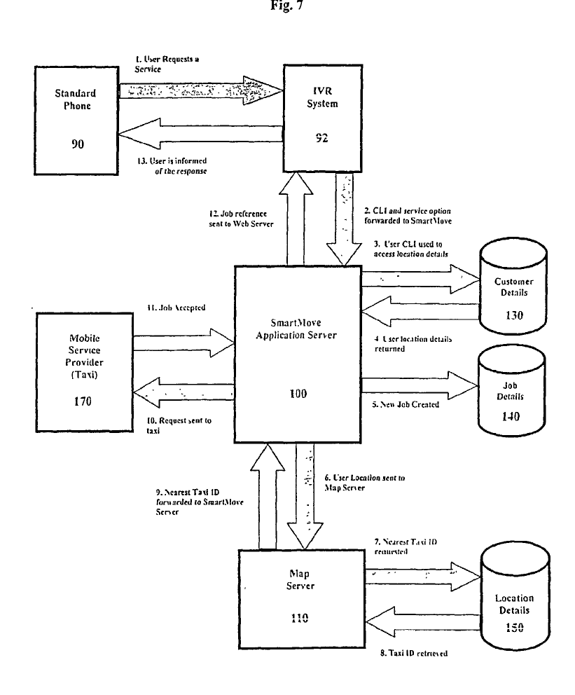

In the case where the end user has access to a standard phone 90 connected to a PSTN 91, the user requests a particular service by voice and this information is forwarded to IVR system 92, as shown in FIG. 7 and as discussed in relation to FIG. 6 above.

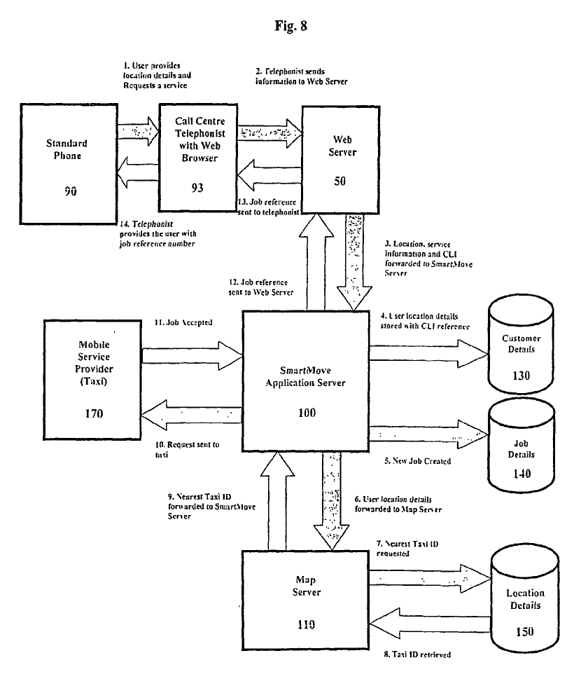

If a call centre telephonist 93 is used instead of IVR system 92, the user will provide its location details and requests the service directly to the telephonist 93 who then forwards the information to web server 50 as illustrated in FIG. 8. The web server then forwards location information, service information and CLI to application server 100. Identical processing to that described above in relation to the IVR system occurs to the point where application server forwards job reference information to web server 50 which in turn forwards this information to the telephonist 93. The telephonist will then provide the job reference number to the end user using standard telephone 90.

FIG. 9 is an example of a display presented to a user by the WEB server 50. This display is provided in response to a request from the end user for information as to the locality of chauffer services in a designated area. In this example, the end user is displayed centrally thereof and the chauffer services which shown if they are within a radius of 3kms of the geographical location of the end user.

The display may depict streets and landmarks at any level of detail capable of being displayed on the monitor device used by the end user, or that may be specifically requested by the end user. A further feature could be for the WEB server to calculate the estimated times of arrival for each of the mobile service providers displayed, so that as well as distance from the end user, there will be a time associated with the provision of a service to that end user.

The next step in the process, is for the end user to make a selection, in this case, which of the two mobile service providers are to be sent a message requesting their services. The end user, in this embodiment, moves a cursor over the chosen mobile service provider and right clicks to bring up a range of options for selection by the end user and by releasing the cursor over the chosen option makes their selection.

The end user may also be able to pay for or lodge a deposit for the service by enabling electronic funds transfer eg credit card, smart card, electronic wallet payment, etc. The simplest option is for the end users name, address and telephone contact to be sent to the mobile service provider as a Small Message Service (SMS) message or e-mail for WEB enabled mobile telephones.

Selected end users could have their end user equipment arranged to automatically select the nearest mobile service provider of a selected or preselected type. For example, a restaurant that often needs the services of a taxi can automate the selection process by only having to enter the number of passengers to be picked up and the preferred type of transport and the user equipment will determine the closest mobile service provider to meet the criteria and order the service with out further operator involvement. All other details such as who and where are constant and the process is simple enough for a hard working waiter to initiate and report when the request has been acknowledged. Of some usefulness is the ability of the mobile service provider to send a SMS message to the originating user to inform them that they have arrived at the pick-up location.

The SMS message to the mobile service provider will be generated by the application server 100 and delivered via the mobile telephone network (through SMS gateway 73) to the chosen mobile service provider. In that regard the IMEI number is used to ensure that the appropriate mobile service provider receives the SMS message and the previously described SMS toolkit can be used to facilitate easier SMS messaging.

The sophistication of the mobile service provider's mobile telephone will determine the ease with which such messages are received, read and responded to. Additional devices including keyboards, data terminals and monitors could be connected to aid the receipt and response to such messages.

The General Packet Radio Service (GPRS) platform may be used to provide an “always on” data connection to the mobile network for the service provider, thus enabling the use of a packet switched network to establish either a data messaging link or a web link. This will provide a further communication option for both the end user and the service provider.

Acknowledgment (as acceptance or rejection) and receipt of the message can be partly automated and/or partly manual, with the acknowledgment message being constructed by the mobile service provider, as they make their way to the end user's advised geographical location. They can use as described previously, an embedded SMS message using an enhanced SIM card in their mobile telephone.

If additional information is required by the mobile service provider, the return telephone number sent to it via the above steps can be used by the mobile service provider to voice contact the end user if need be.

In FIG. 9 there are shown two chauffer services wherein chauffer service 1 is located 3 kms away and chauffer service 2 is located 2.1 kms away. In thus example, the closest chauffer service (number 2) is chosen. However, if chauffer number 1 were offering reduced standard fares it may be possible for the end user to be made aware of that offer and then be required to make a decision based on the trade off between the convenience of a shorter waiting time against a cheaper fare.

In FIG. 10 the end user has requested information as to the geographical location of plumbers and gas fitters within a 3 km range. The display shows that there are 3 mobile service providers in the distance range chosen by the end user. Only one of those mobile service providers is both a plumber and gas fitter. Selection of which mobile service provider is to be used by the end user can be enhanced if the end user is able to obtain additional information about the services provided by each of the displayed mobile service providers. For example, if call out costs and hourly rates were known for each mobile service provider, that information could also be displayed to the end user. It will be possible for indiividual mobile service providers to choose to register their rates with the WEB server either providing these figures manually to an operator who enters them onto the WEB information available to the users or by way of authorised access to restricted areas of the WEB server database which will allow the mobile service provider to update their own information on an ad hoc basis.

It is also possible to allow the end users to provide information about themselves, including for example pick-up address and service type preference (eg wheelchair accessible vehicle).

The end user thus may be able to increase their knowledge about the respective mobile service providers by moving the cursor over each of the mobile service provider logos and having presented to them relevant information. Logos may have various visual or audible characteristics that indicate status, discounts, features of the service, etc. relevant to the particular mobile service provider. The end user may also single or double click on an icon representing a mobile service provider to obtain further information from a database held on the WEB server. In a yet further arrangement it may be possible to direct the end user to the home page URL of the mobile service provider.

It will be appreciated by those skilled in the art, that the invention is not restricted in its use to the particular application described and neither is the present invention restricted to its preferred embodiment with regards to the particular elements and/or features described or depicted herein. It will be appreciated that various modifications can be made without departing from the principles of the invention. Therefore, the invention should be considered to include all such modifications and variations.

1. A method of providing access to an end user to one or more mobile service providers providing a service, the method including:
receiving from the end user a request to access one or more mobile service providers within a predetermined region;
supplying the end user with data relating to the geographical location of the one or more mobile service providers within said predetermined region;
receiving from the end user data relating to a selected one of the one or more mobile service providers within the predetermined region; and
providing details of the end user to the selected mobile service provider.

2. A method according to claim I wherein details of the end user as supplied to the selected mobile service provider include end user identification and location data.

3. A method according to claim 1 or 2 further including the step of providing the end user with a confirmation that the mobile service provider has accepted or rejected the end user's request.

4. A method according to claim 3 wherein said confirmation includes a job reference number.

5. A method according to claim 1 wherein the information relating to the geographical location of the one or more mobile service providers also includes information relating to the service provided.

6. A method according to claim 5 wherein the information relating to the service provided includes information relating to the cost of the service provided.

7. A method according to claim 1 wherein the end user's selection of the selected mobile service provider is based on the geographical location of the selected mobile service provider.

8. A method according to any one of claims 5 or 6 wherein the end user's selection of the selected mobile service provider is based on the information relating to the service provided.

9. A method according to any one of claims 5 or 6 wherein the end user's selection of the selected mobile service provider is based on both the geographical location of the mobile service provider and the information relating to the service provided.

10. A method according to claim 1 wherein said information supplied to the end user relating to the geographical location of the one or more service providers is in the form of a graphical representation.

11. A method according to claim 5 wherein the information relating to the service provided is in the form of a graphical representation.

12. A system for providing access to an end user to one or more mobile service providers, the system including:
an end user interface to allow the end user to request and receive data relating at least to the geographical location of one or more mobile service providers within a predetermined region;
an application server for receiving and providing data to and from the end user interface;
one or more databases storing data relating to the one or more mobile service providers that are registered;
a map server for processing and providing data relating to the geographical location of the one or more service providers to the application server, and for retrieving and updating the one or more databases;
a mobile location engine for determining the location of the one or more mobile service providers and providing this data to the map server.

13. A system according to claim 12 wherein said one or more databases also include data relating to the end user, data relating to the particular services provided by the one or more mobile service providers, and data relating to booking orders.

14. A system according to claim 12 or 13 wherein said end user interface is a web browser connected to the Internet which is in turn connected to a web server connected to the application server.

15. A system according to claim 12 or 13 wherein said end user interface is a WAP microbrowser connected to a mobile communications network which is in turn connected to a WAP gateway, which is connected to the application server via a web browser.

16. A system according to claim 12 or 13 wherein said end user interface is an SMS mobile phone connected to a mobile communications network which is in turn connected to an SMS gateway which is connected to the application server.

17. A system according to claim 12 or 13 wherein said end user interface is a PSTN telephone connected to an Interactive Voice Recognition (IVR) system which is connected to the application server.

18. A system according to claim 12 or 13 wherein said end user interface is a PSTN telephone connected to a call centre having a web browser connected to the application server via the Internet and a web server.

19. A method of providing access to an end user to one or more mobile service providers providing a service, the method including:
receiving from the end user a request to access one or more mobile service providers within a predetermined region;
automatically selecting one or more mobile service providers in accordance with one or more criteria provided by the end user; and
providing details of the end user to the selected one or more mobile service providers.

20. A method according to claim 19 wherein said criteria includes geographical proximity to the end user, cost and service type.

21. A method according to claim 19 or 20 wherein details of the end user as supplied to the selected mobile service provider include end user identification and location data.

22. A method according to claim 19 further including the step of providing the end user with a confirmation that the mobile service provider has accepted or rejected the end user's request.

23. A method according to claim 22 wherein said confirmation includes a job reference number.

24. A method according to any one of claims 1 to 11 wherein said predetermined region is a region specified by the user.

25. A method according to claim 1 wherein said predetermined region is a region calculated utilizing the end user's current geographic location.
